(19) United States
(12) Patent Application Publication
(10) Pub. No.: US 2009/0113480 A1
(43) Pub. Date: Apr. 30, 2009

(54) NON-MEDIA-CENTRIC PACKAGING OF CONTENT

(75) Inventors: James E. Allard, Seattle, WA (US); David Sebastien Alles, Seattle, WA (US); Nicholas R. Baker, Cupertino, CA (US); Adam T. Berns, Bellevue, WA (US); Steven Drucker, Bellevue, WA (US); James C. Finger, Kirkland, WA (US); Todd E. Holmdahl, Redmond, WA (US); Oliver R. Roup, Seattle, WA (US); David H. Sloo, Menlo Park, CA (US); Curtis G. Wong, Medina, WA (US); Dawson Yee, Bellevue, WA (US)

Correspondence Address: AMIN, TUROCY & CALVIN, LLP, 127 Public Square, 57th Floor, Key Tower, CLEVELAND, OH, 44114, US

(73) Assignee: Microsoft Corporation, Redmond, WA (US)

(21) Appl. No.: 11/877,827

(22) Filed: Oct. 24, 2007

(51) Int. Cl. G06F 3/00

(52) U.S. Cl. 725/46

(57) ABSTRACT

The claimed subject matter relates to an architecture that can establish a tailored and/or personalized content channel based various aspects of a social network. The content channel can be interfaced with one or more devices, and can be configured to serve content based upon a content schedule. The content schedule can be programmed based upon selections or recommendations of a member of a user's social network. The architecture can further maintain presence information associated with a member of the social network, such as indicia of the member's current behavior or activity.

### CROSS-REFERENCE TO RELATED APPLICATIONS

This application is related to co-pending U.S. patent application Ser. No. 11/767,724 entitled, “TAILORED CHANNEL FOR CONTENT CONSUMPTION”, filed Jun. 25, 2007. The entirety of this application is incorporated herein by reference.

### BACKGROUND

Historically, the notion of a “channel” such as a television channel or radio station evolved in connection with allocation of scarce broadcast spectrum. Today, given numerous technological advances in data delivery (e.g., new protocols or platforms), infrastructure build-ups (e.g., laying fiber optic cable, launching satellites, or constructing regional towers), as well as a large-scale and widespread migration toward content delivery methods that employ backbones with high bandwidths and/or a surplus of data channels, suggest that one of the original notions of a “channel” based upon limited broadcast spectrum is no longer relevant.

One result is that channels are now generally thought of more as brands that often serve the same or similar content, but package the content differently. For example, American Broadcasting Channel (ABC) and National Broadcasting Channel (NBC) may deliver a news story about the same event, but package the news story in a different way. Likewise, Home Box Office (HBO) and Showtime may both provide the same type of content (e.g., feature films), yet select different content to serve based upon a different set of affiliations with content producers or providers.

Often, well-known “channels” are actually a suite of channels such as ABCSports, ABCFamily, etc., each directed to a particular demographic or audience, but all of them in some way associated with the ABC channel or brand, which typically provides content in a media-centric fashion such as selecting content based upon a type of media. While many of these channels deign to provide somewhat tailored content, they are still limited by numerous constraints as well as motivated by economic concerns of reaching the maximum potential audience, and thus, the content consumer has no or very little decision-making input. As a result, content consumers have no conventional means for establishing a content channel that provides all of the content he or she desires, yet none of the content he or she does not desire. Moreover, conventional channels typically only provide content in one particular format that is suitable for only one or a small number of similar device types. Accordingly, a content consumer has very few device type options with respect to receiving content from a conventional channel.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can facilitate selection and/or filtering of content based upon a social network in order to, e.g., provide access to content in a non-media-centric manner. To these and other related ends, the architecture can provide a content channel that can be configured to serve content to a device in accordance with a content schedule. In addition, the architecture can program and/or populate the content schedule based upon a social network of a user.

In accordance therewith, the architecture can maintain a contact list that includes members of the social network. Thus, the contact list can effectively describe or define the social network as well as include additional information about the member such as account ID or other suitable designations. The contact list can be imported, updated, or translated from disparate applications or devices. Given that a relationship between the user and the member is likely to pre-exist adding the member to the contact list, the architecture can leverage the pre-existing relationship in a variety of ways such as utilizing the knowledge of one party to provide suitable or appropriate selections for another party with whom there is an established relationship. On the one hand, a user is often more likely to trust the judgment of a member of his or her social network, while, on the other hand, the member (e.g., friend, colleague, relative . . . ) is often privy to the user's tastes, likes, or interests.

According to an aspect, the architecture can enable the user to subscribe to content choices made by members of one of the user's social networks. In essence, the above can allow the user to subscribe to people rather than media-centric brand content outlets. Moreover, the architecture can enable the user to specify certain trust relationships between the user and a member of the social network. In particular, the user can specify that a first member has excellent taste in movies, whereas a second member has good judgment with respect to music. Thus, the user can designate that the first member is trusted for movie content, while the second member is trusted for music content. It is to be appreciated that the trust relationship can also relate to favorite lists compiled by the member, in some cases specifically for the user or for some users but not others. Additionally, the trust relationship can pertain to permissions or access that exist between the user and the member.

In another aspect, the architecture can maintain presence information as it relates to members of a social circle. For example, the presence information can indicated that a member of the user's social network is currently “online”, such as currently watching television, for instance. The presence information can also indicate the precise content being consumed as well as provide a summary or statistics relating to the consumed content. In other cases, the presence information can relate to content that is scheduled for later consumption or content that exists on a favorite list. In essence, the architecture can provide a rich indication of the activity or behavior of the member such that the user can in some ways share in the experiences or just be informed about the member's presence.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system that can facilitate selection and/or filtering of content in order to tailor a content channel based upon a social network.

FIG. 2 illustrates a block diagram of a system that can employ a contact list in connection with a social network.

FIG. 3 depicts a block diagram of a system that can maintain rich presence information with respect to a social network.

FIG. 4 illustrates a block diagram of a system that can utilize trust relationships extant in a social network in order to facilitate population of a content schedule.

FIG. 5 is a block diagram of a system that can intelligently configure a content schedule and/or a content channel.

FIG. 6 depicts an exemplary flow chart of procedures that define a method for facilitating tailoring of a content channel based upon various aspects of a social network.

FIG. 7 illustrates an exemplary flow chart of procedures that define a method for maintaining data associated with a presence of a member of a social network.

FIG. 8 is an exemplary flow chart of procedures that define a method for managing data associated with relationships of a social network.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect, feature, embodiment, or design described herein as “exemplary” is not necessarily to be construed as preferred or advantageous over other. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

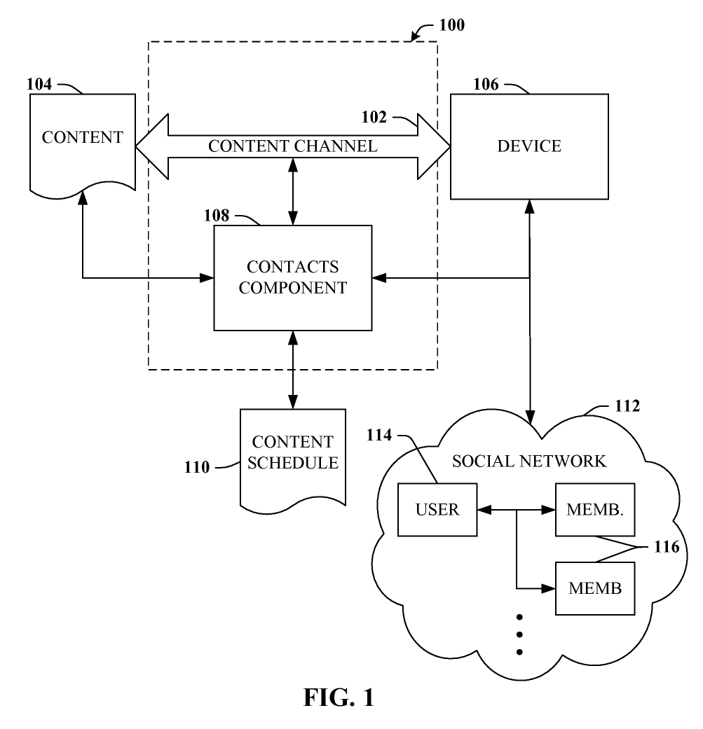

Referring now to the drawings, with reference initially to FIG. 1, a system 100 that can facilitate selection and/or filtering of content in order to tailor a content channel based upon a social network is depicted. Generally, the system 100 can include a content channel 102 that can be configured in accordance with a content schedule 110 to serve content 104 to a device 106. The content channel 102 is typically a channel associated with and/or defined or configured by a single family or household. The content 104 can be entertainment-based or educational/informative content including but not limited to movies, television programs, games, web content, literature, instructional or learning content. The content 104 can also include advertisement-based content 104 such as commercials or incentives for goods or services. Furthermore, the content 104 can be subscription-based, free or public domain content 104, as well as content created by individuals or entities associated with a social network 112 (e.g., a member 116 or a user 114).

The device 106 can be substantially any electronic or controller-based I/O device that can be employed to deliver content 104. A common type of device 106 can be, e.g., a television or associated peripherals or devices dependent upon the television such as a Digital Versatile Disc (DVD) player, a game console, or a media center. In accordance with an aspect, the device 106 can also be a personal computer (e.g., desktop, laptop, tablet, mobile, handheld, wearable . . . ), stereo or media player/recorder (either hardware or software including a Digital Video Recorder (DVR) or associated cache or data store), a cellular or smart phone, a handheld game console, and so on.

It is to be appreciated that the content channel 102 can be simultaneously or sequentially interfaced to a plurality of devices 106 and, as such, the content channel 102 can serve content 104 to multiple devices 106 (e.g., serve content 104 to a television in a bedroom as well as a television in another room) as well as to multiple device types (e.g., serve content 104 in one case to a television and in another case to a desktop computer). In accordance therewith, it is readily apparent that content channel 102 is not necessarily limited to a single format for the content 104. Rather, given the potential for a single content channel 102 to serve a variety of different types of device 106, the content channel 102 can propagate many different content formats. Hence, while conventional “channels” are associated with a particular broadcast spectrum, or exist as data channels configured for a very specific device type or a very specific content format, the content channel 102 is not necessarily so limited.

The system 100 can also include a contacts component 108 that can populate in whole or in part the content schedule 110 based upon a social network 112. The content schedule 110 can be employed to configure the content channel 102 and/or particular content 104 that is served by the content channel 102 as well as types of content 104 that can be served by the content channel 102. Hence, by populating the content schedule 110, the contacts component 108 can effectuate content 104 delivery to the device 106. As described supra, the content schedule can be populated based upon the social network 112.

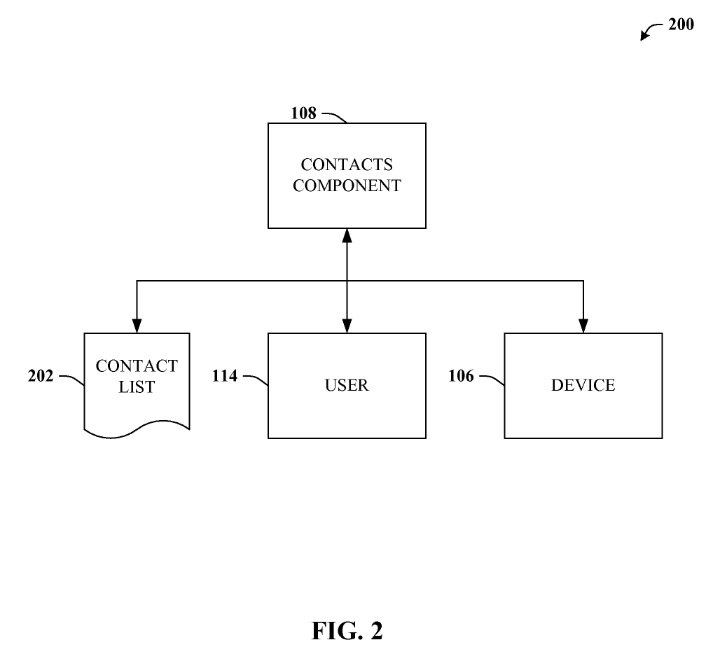

Social network 112 can relate to a particular user 114, which can be, e.g. a manager of the content channel 102 as well as a user of the device 106. In particular, the user 114 can maintain relationships with friends, family, colleagues, associates, entities, trusted sources or resources, and so on, any or all of which can be members 116 of the user's 114 social network 112. Oftentimes the social network 112 can be defined or described by a contact list (discussed in more detail with reference to FIG. 2) that, inter alia, can identify the members 116.

It should be appreciated that by employing the social network 112 to populate the content schedule 110, content 104 can be selected in a non-media-centric manner. For example, conventional systems package content based upon media channels or outlets, however, in accordance with the claimed subject matter, content 104 can be packaged based upon, e.g. information associated with the social network 112 of the user 114. Thus, instead of subscribing to particular types of media (e.g., sports channels, history channels, general interest channels), the user 114 can effectively subscribe to people. Hence, the user 114 need not be limited by, say, a few hundred channels, but can potentially have access to literally millions of channels for content. Moreover, given that the contacts component 108 can populate the content schedule 110 based upon the social network 112, the content 104 can be inherently tailored to the user 114 by virtue of established social relationships, shared interests, and other intrinsic factors extant in a given social network 112.

It should be appreciated that numerous social networks 112 can exist for a single user 114. For example, a user can have a first social network 112 that includes only family members, a second social network 112 that includes only people or entities who share similar tastes in content 104 or a particular type or category of content 104. In addition, the social network 112 can depend upon the device 106 or type of device 106. For instance, the first social network 112 can apply to a cellular phone (e.g. potentially including all contacts stored on the phone) whereas the second social network 112 can apply to a television (e.g., potentially including contacts who recommend suitable television programs).

It should be further appreciated that the contacts component 108 can populate the content schedule 110 based upon input from the user 114. Thus, the user 114 can expressly specify that a first member 116 has suitable taste in music content 104, whereas a second member 116 often exhibits suitable or appropriate behavior with respect to television programming, while a third member 116 is trusted for sports-related content 104. Hence, the contacts component 108 can populate the content schedule 110 based upon the above specifications with information obtained from the social network 112. Accordingly, when the user 114 activates a stereo, content 104 provided or recommended by the first member 116 can be selected, and likewise content selected or supplied by the second and third members 116 can be utilized for general television viewing or sports content 104, respectively.

Turning now to FIG. 2, a system 200 that can employ a contact list in connection with a social network is illustrated. The system 200 can include the contacts component 108 that can populate the content schedule 110 based upon the social network 112 of a user 114 of the device 106. As indicated supra, the contacts component 108 can also maintain a contact list 202, which can define or describe the social network 112 as well as identify members 116 of the social network 112. The contacts component 108 can provide an interface for creating or editing the contact list 202. In addition or in the alternative, the contacts component 108 can import or update the contact lists 202 from a potentially disparate application or device 106.

For example, a chat or email application, or a device 106 can include a list of contacts as well as related information such as account ID or an address associated with the contact. Members 116 of the contact list 202 can be imported from such a list of contacts. It should be understood that the members 116 can be associated with particular people as well as, in some cases, with entities. Thus, the contact lists 202 can in the later case include links or references to resources, which can also be obtained or updated from the application or device 106, such as by way of a favorites' list that, e.g. identifies an entity and associated information.

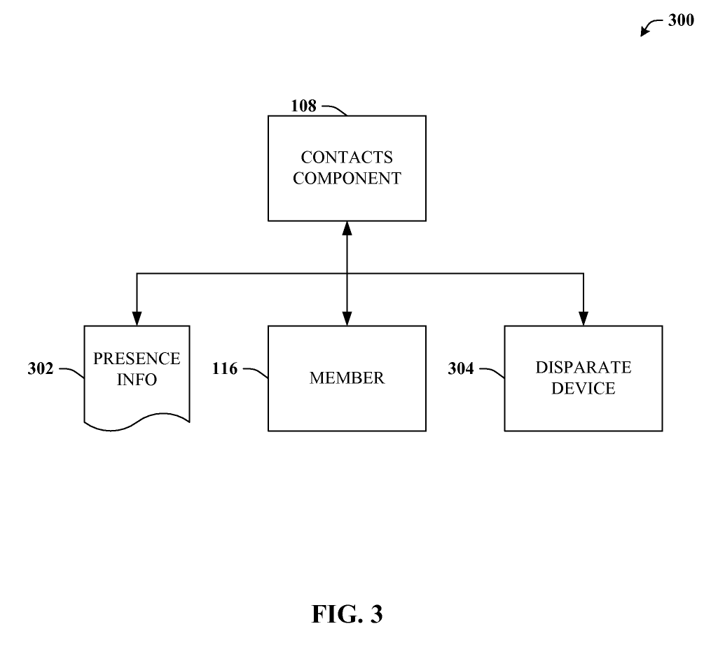

With reference now to FIG. 3, a system 300 that can maintain rich presence information with respect to a social network can be found. In general, the system 300 can include the contacts component 108 that can populate the content schedule 110 based upon information obtained relating to the social network 112, as substantially described supra. In addition, the contacts component 108 can maintain presence information 302 associated with a member 116 of the social network 112.

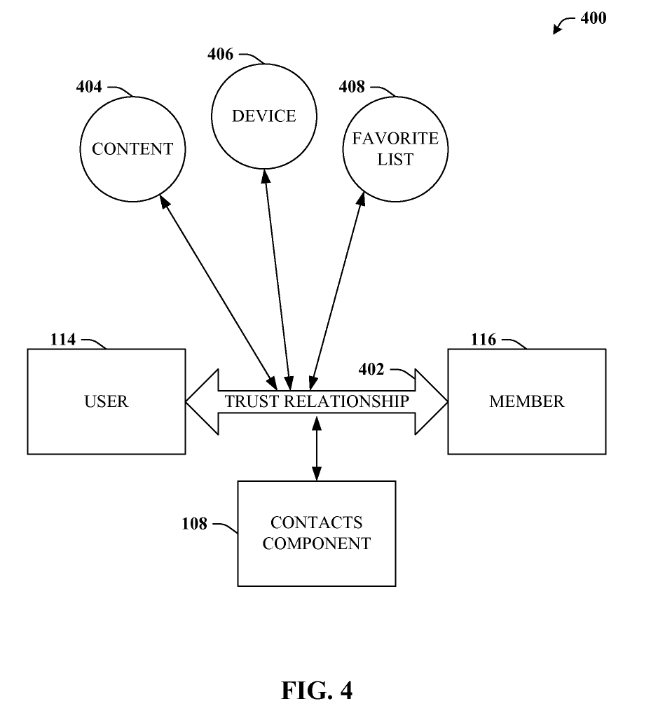

According to an aspect of the claimed subject matter, the presence information 302 can relate to a disparate device 304 currently employed by the member 116. For example, consider the scenario in which Ashley (e.g., user 114) has a social network 112 that includes her friend, Ross (e.g., member 116). Now suppose that Ashley is curious about what Ross is doing right now. In accordance with the foregoing, the contacts component 108 can provide presence information 302 to indicate, e.g. that Ross is currently watching television (e.g., disparate device 304). It is to be appreciated that suitable controls can be implemented such that Ross must first enable such a feature or allow such information 302 to be shared and/or shared particularly with Ashley, which is further detailed in connection with FIG. 4.

In another aspect of the claimed subject matter, the presence information 302 can relate to content currently being consumed by the member 116. Thus, in addition to the fact that Ross is currently watching television, the contacts component 108 can supply presence information 302 detailing exactly what Ross is watching. Consider further the case in which Ross is playing a sports-based video game. Such presence information 302 can be provided as well as various additional information 302 such as, e.g., what team Ross is playing, the current score, a summary of the game up to this point, an estimated time until Ross's game will be over, data relating to a queue for opponents for a next game, and so forth.

In another aspect of the claimed subject matter, the presence information 302 can relate to content scheduled for consumption by the member 116. For instance, Ross can maintain a list of content scheduled for consumption such that Ashley can access the list and perhaps decide to consume the same content or otherwise experience the content simultaneously. In addition, the contacts component can provide communication channels between the user 114 and the member 116. The communication can be audio, visual, textual, or combinations thereof. Furthermore, the communications can be integrated with suitable features of the content and/or the device 106.

Hence, while presence information 302 indicates that Ross is currently playing a competitive first-person shooter game against a third party, Ashley can message Ross to challenge him in the next game. As another example, the contacts component 108 can indicated that Ross has scheduled several different types of content for consumption, for which Ashley can provide input in order to decide among the list. It is of course impossible to describe each and every potential aspect or feature that can be utilized in connection with the claimed subject matter, however, given description and examples provided herein, one can easily appreciate that numerous other features can be applicable to the appended claims.

FIG. 4 illustrates a system 400 that can utilize trust relationships extant in a social network in order to facilitate population of a content schedule. The system 400 can as well include the contacts component 108 as substantially described supra. In addition to what has been described above, the contacts component 108 can also manage a trust relationship 402 between the user 114 and one or more members 116 of the social network 112. The trust relationship 402 can designate types of access, permissions, privileges, preferences, etc. that exist between the user 114 and the member 116.

In one aspect of the claimed subject matter, the trust relationship can pertain to a content type 404. For instance, a user 114 can designate that a first member 116 is a trusted for, say, music content 104, web destination content 104, and/or gaming content 104, whereas a trusted relationship 402 can exist with a second member 116 with respect to other content types 404, or, conversely with no content types 404 (e.g. the member 116 is not a trusted source for any particular content type 404). Moreover, the trust relationship 402 can indicated that the user 114 has access to the presence information 302 associated with the member 116 for certain content 104 and/or content types 404 (e.g. the user 114 can obtain data indicating when the member is “online” with respect to the content 104 and/or content type 404).

Likewise, according to another aspect of the claimed subject matter, the trust relationship 402 can pertain to a device type 406 and/or a particular device 106. For example, the member 116 can be a preferred source for device type 406 or a particular device 106 in a similar manner as seen with content types 404 or content 104. The contacts component 108 can also maintain the permissions as to presence information 302 available to the user 114 by way of the trust relationship 402.

In yet another aspect of the claimed subject matter, the trust relationship 402 can pertain to a favorite list 408. The favorite list 408 can include a list of content 104 that is preferred or recommended by the member 116. It is to be appreciated that just as a user 114 can have multiple members 116 included in a particular social network 112, a given member 116 can be a member 116 of multiple social networks 112 organized by respective users 114. Appreciably, content 104 recommended by the member 116 to a first user 114 may differ from content 104 the member 116 would recommend to a second user 114. For example, what a given member 116 would recommend to his/her grandmother will generally differ from what is recommended to friends. Hence, the favorite list 408 can vary based upon the trust relationship 402 and/or can be tailored for particular users 114 or categories of users 114, which can be effectuated by the trust relationship 402 managed by the contacts component 108. Hence, the contacts component 108 can employ the trust relationship 402 in order to populate the content schedule 110. For instance, the content schedule 110 can be populated with content currently being consumed by the member 116 as well as with content that exists on the member's 116 favorite list 408, provided that suitable permissions, access, and/or trust relationships 402 permit such.

In accordance with the foregoing, and returning to the scenario provided supra, it is to be appreciated that, e.g. the trust relationship 402 can indicate whether or not a relationship of trust exists between Ashley and Ross, at least for certain content types 404, device types 406, or recommended content (e.g., favorite list 408). In addition, the trust relationship 402 can indicate whether Ashley has access to Ross's presence information 402 for certain devices 106 or device types 406, for certain content 104 or content types 404, or during certain times. In addition, the trust relationship 402 can denote that, e.g., Ashley trusts Ross's judgment with respect to music and video games, and, as a close friend, Ross is particularly well-positioned to understand content types 404 that are appropriate for Ashley, so he can tailor his recommendations or favorite list 408 expressly for Ashley and/or others like Ashley.

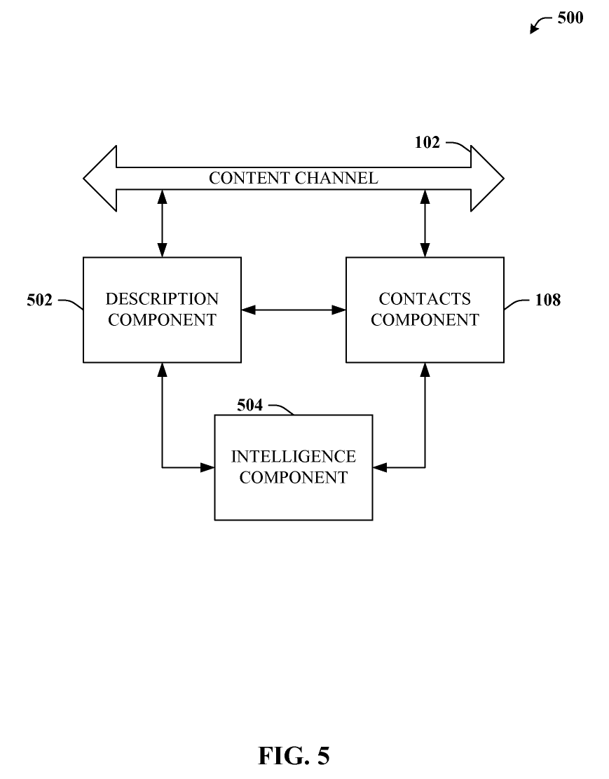

With reference now to FIG. 5, a system 500 that can intelligently configure a content schedule and/or a content channel is provided. Generally, the system 500 can include the contacts component 108 that can populate the content schedule 110 based upon a social network 112, as described herein. For example, in many cases, the contacts component 108 can populate the content schedule 110 based upon express input from a user 114 of the device 106 and/or from a manager of the content channel 102. However, in other cases, the contacts component 108 can employ machine learning techniques to provide for determinations or inference that relate to, e.g., selecting or filtering items supplied to the content schedule 110, as will be explained in more detail infra.

In addition, the system 500 can include a description component 502 that can receive the content schedule 110, and that can configure the content channel 102 in accordance with the content schedule 110. Furthermore, the description component 502 can also facilitate appropriate selection or filtering as it relates to content 104 served by the content channel 102. For example, while a common situation exists in which the content schedule 110 expressly indicates the exact content 104 to serve, other situations exist in which the exact content 104 is not specified. Thus, in the latter situation, the description component 108 can dynamically and/or intelligently choose the content 104 to be served, an operation that can be aided by an intelligence component 504. For instance, when the content schedule 110 specifies a time to serve content 104, a content type 404 to serve, a device type 406 in which to serve the content 104, etc., but does not expressly indicate certain content 104, then the actual content 104 selected may need to be intelligently determined. Likewise, when certain content is forbidden to be served by the content channel 102 (e.g. by a manager of the content channel 102), it may be necessary to intelligently determine or infer what content should be filtered.

For aspects relating to intelligently selecting content 104, data sets indicative of the following can be employed: a history of content consumption on the content channel 102; a history of explicit selections, preferences or guidelines set forth by the content manager; demographics relating to the content manager or to a designated primary content consumer for the content channel 102; associations or relationships with other content managers (e.g., trust relationships 402 between members 116 of a social network 112); an identity of a current content consumer (e.g., the user 114 or member 116); as well as other data sets described herein, or those that are otherwise appropriate.

For aspects relating to intelligently filtering content 104, all or a subset of the data sets described above can be employed. In addition, the content 104 itself can be examined for certain features extent in, e.g., metadata, keywords, or visual indicia that can be suggestive of violence, vulgarity, nudity, and so on. Furthermore, data sets indicative of content ratings or warnings, generally maintained by industry associations related to one or more respective types of content 104 are very common and can be employed as well. In similar ways, the contacts component 108 can employ determinations or inferences associated with selecting or filtering items supplied to the content schedule 110. In either case, appropriate inferences can be performed internally by the respective component, or with the aid of the intelligence component 504.

In order to make a determination related to selection or filtering, the intelligence component 504 can examine the entirety or a subset of the data available and can provide for reasoning about or infer states of the system, environment, and/or user from a set of observations as captured via events and/or data. An inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

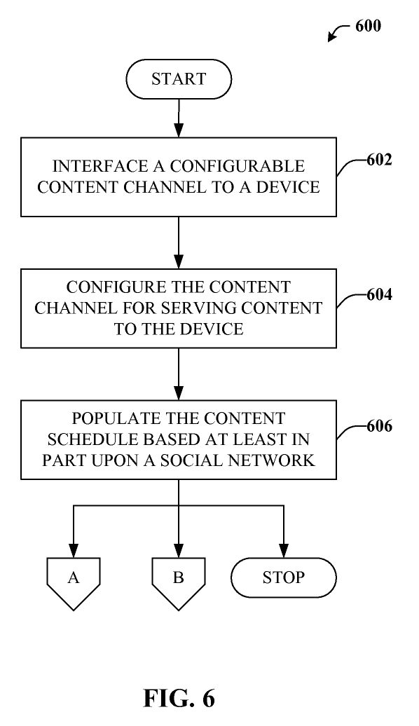

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 6, an exemplary method 600 for facilitating tailoring of a content channel based upon a social network is depicted. At reference numeral 602, a configurable content channel can be interfaced to a device. It is to be appreciated that a single content channel can be interfaced to numerous devices, and, likewise, a single device can be interfaced to multiple content channels. Furthermore, a device interfaced to a content channel can be in some cases only transactions that are propagated by way of the one or more interfaced content channels. For example, a cell phone (e.g., interfaced device) can be configured to receive web content only by way of the content channel but can perform other functions such as making outgoing calls as would normally be available. In other cases, however, all transactions may be provided by way of the content channel, and therefore may be subject to various requirements or conditions before certain features or functionality can be utilized.

At reference numeral 604, the content channel can be configured for serving content to the device in accordance with a content schedule. The content schedule can specify a wide range of information such as suitable content, appropriate times for certain content, as well as types of content that should be selected or filtered and/or types of devices that should or should not be utilized. At reference numeral 606, the content schedule can be populated based at least in part upon a social network associated with a user of the device. In accordance therewith, the content channel can ultimately be configured to serve content based upon associations or relationships for a social network. Hence, a content channel can be provided in a manner that, unlike conventional channels, need not be media-centric.

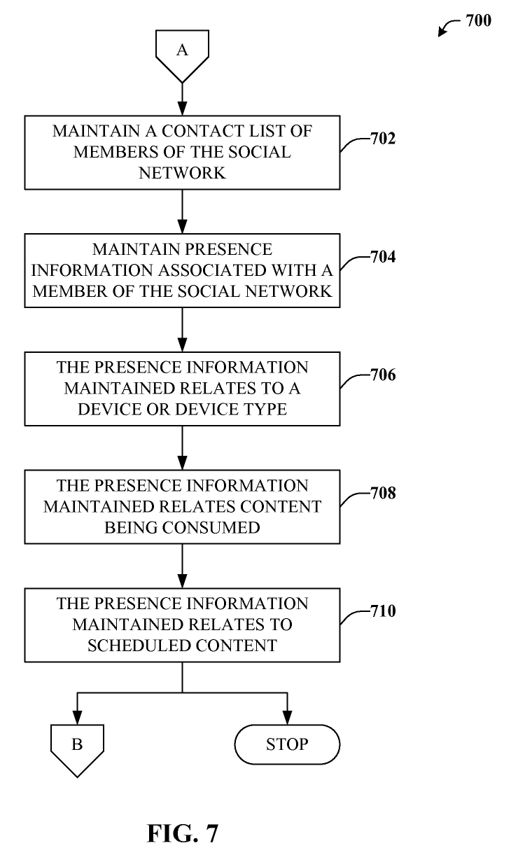

Referring to FIG. 7, a method 700 for maintaining data associated with a presence of a member of a social network is provided. Generally, at reference numeral 702, a contact list of members of the social network can be maintained. The contact list can define the social network for the user as well as provide various means of communicating with the member such as account IDs or reference information. It should be appreciated that the contact list can be created independently as well as be imported or updated from, e.g. application-specific or device-specific contact lists or favorites lists.

At reference numeral 704, presence information associated with a member of the social network can be maintained. The presence information can relate to various behavior or selections associated with members of a social network. For example, Internet chat utilities commonly provide presence information to inform users when other users have logged onto the chat system, when communications are incoming or being created, and so forth. Similar features can be extended to the claimed subject matter such that a user can be apprised of behavior or content associated with various members within a social network.

At reference numeral 706, the presence information maintained can relate to a device or a device type currently in use by the member. For example, the presence information available to the user can relate to, e.g. a device that is currently serving content to one of the user's contacts, which can provide an indication of what the contact is doing presently. At reference numeral 708, the presence information maintained can relate to content being consumed. For instance, the user can be supplied information relating to the contact's present content selection such as title, genre, stats associated with the content or the platform and so on. At reference numeral 710, the presence information maintained can relate to scheduled content. Thus, the user can be apprised not only of current behavior or activity of the member, but upcoming or scheduled activity as well. Hence, the user can, e.g., choose to experience the scheduled content with the member.

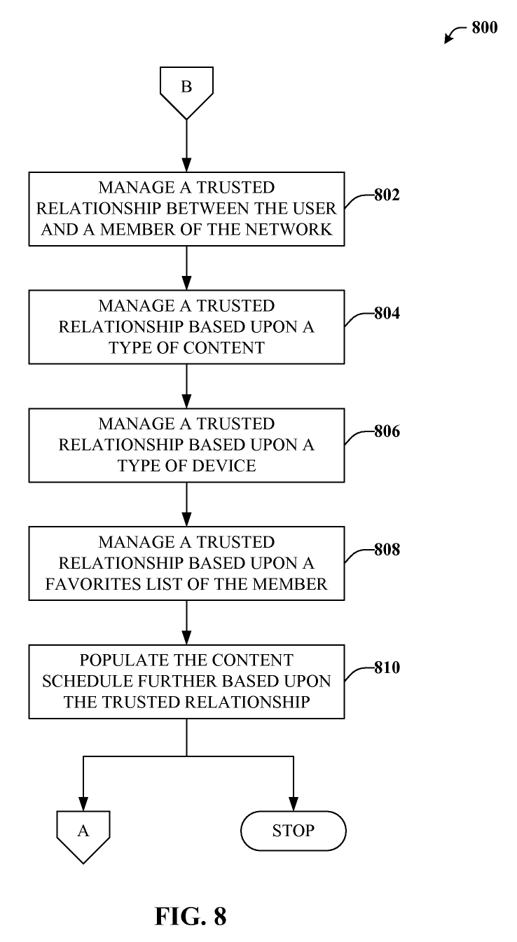

Turning now to FIG. 8, a method 800 for managing data associated with relationships of a social network is illustrated. Typically, at reference numeral 802, a trust relationship can be managed between the user and the member of the social network. At reference numeral 804, the trust relationship can be based upon a content type. As one example of the foregoing, the user can designate and/or it can be determined or inferred that a member of the social network is a suitable source for a particular type of content. Thus, the content schedule can be populated with content provided by or recommended by the member when the content relates to the designated type.

At reference numeral 806, the trust relationship can be managed based upon a device or device type. As with the above where the trust relationship can be managed based upon content type, here, the trust relationship can be similarly managed based upon the device or device type employed by the user. In particular, certain trust relationships can exist with respect to a device. At reference numeral 808, the trust relationship can be managed based upon a favorite list associated with the member. For instance, the member can maintain his or her own favorites list that may be suitable for the user the favorites list can include content tailored or recommended specifically for the user or a class of user. At reference numeral 810, the content schedule can be populated further based upon the trust relationship.

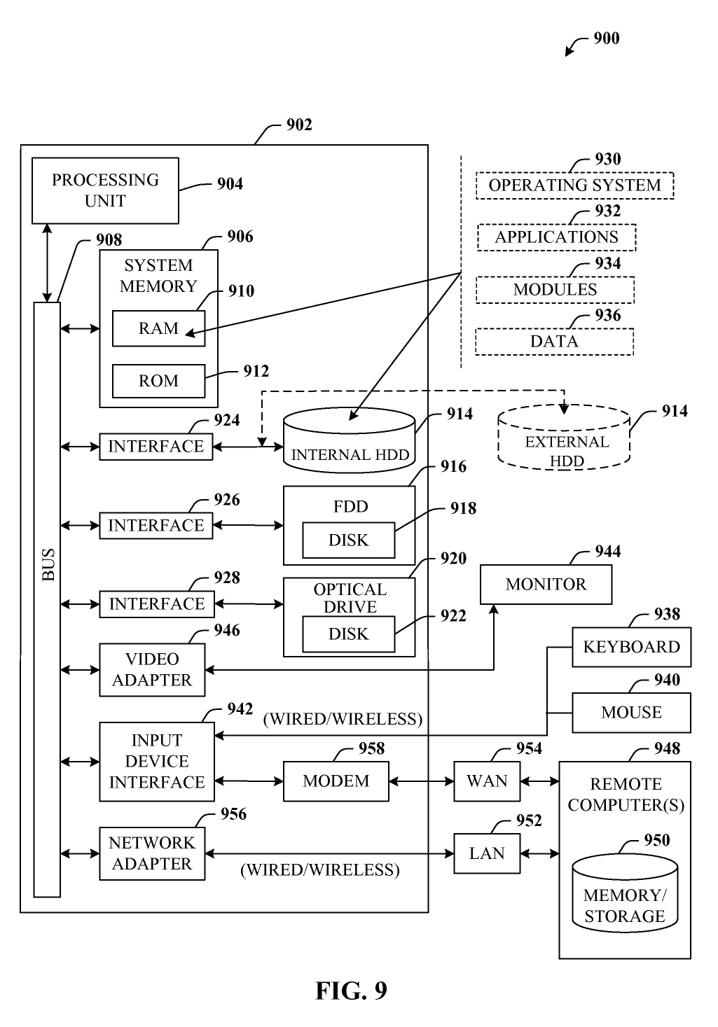

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above can be implemented in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the claimed subject matter.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 9 Mbps (802.11a) or 54 Mbps (802.11b) data rate, for example, or with products that contain both bands (dual band), so the networks can provide real-world performance similar to the basic 9BaseT wired Ethernet networks used in many offices.

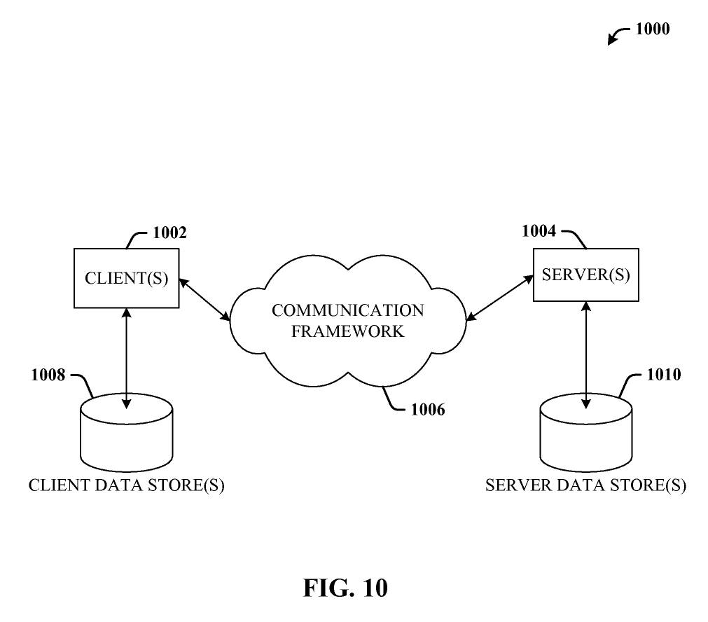

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that utilizes social network information in order to tailor a content channel, comprising:
a content channel that is configured in accordance with a content schedule to serve content to a device; and
a contacts component that populates the content schedule based upon a social network of a user of the device.

2. The system of claim 1, the device is at least one of a television, a gaming console, a computer, a media player, a media cache, or a phone.

3. The system of claim 1, the contacts component maintains a contact list of members of the social network.

4. The system of claim 1, the contacts component maintains presence information associated with a member of the social network.

5. The system of claim 4, the presence information relates to a disparate device currently employed by the member.

6. The system of claim 4, the presence information relates to content currently consumed by the member.

7. The system of claim 4, the presence information relates to content scheduled for consumption by the member.

8. The system of claim 1, the contacts component manages a trust relationship between the user and a member of the social network.

9. The system of claim 8, the contacts component populates the content schedule based upon the trust relationship.

10. The system of claim 8, the trust relationship pertains to a content type.

11. The system of claim 8, the trust relationship pertains to a type of device or a particular device.

12. The system of claim 8, the trust relationship pertains to a favorite list associated with the member.

13. The system of claim 12, the favorite list varies according to the trust relationship.

14. The system of claim 1, further comprising a description component that receives the content schedule, and that configures the content channel in accordance with the content schedule.

15. The system of claim 14, the content or a portion of the content is subscription-based.

16. The system of claim 14, the content or a portion of the content is created by the member.

17. A method for facilitating tailoring of a content channel based upon a social network, comprising:
interfacing a configurable content channel to a device;
configuring the content channel for serving content to the device in accordance with a content schedule; and
defining the content schedule based at least in part upon a social network associated with a user of the device.

18. The method of claim 17, further comprising at least one of the following acts:
maintaining a contact list of members of the social network;
maintaining presence information associated with a member of the social network, the presence information relating to a device or device type currently in use by the member;
maintaining presence information associated with a member of the social network, the presence information relating to content currently being consumed by the member; or
maintaining presence information associated with a member of the social network, the presence information relating to content scheduled for consumption by the member.

19. The method of claim 17, further comprising at least one of the following acts:
managing a trusted relationship between the user and a member of the social network;
managing a trust relationship based upon a type of content;
managing a trust relationship based upon a type of device managing a trust relationship based upon a favorites list associated with the member; or
populating the content schedule further based upon the trust relationship.

20. A system for facilitating tailoring of a content channel in accordance with a social network, comprising:
means for coupling a configurable content channel to a device;
means for programming the content channel for providing content to the device in accordance with a content schedule; and
means for populating the content schedule with information associated with a social network of a user of the device.
